(19) United States
(12) Patent Application Publication
(10) Pub. No.: US 2006/0121268 A1
(43) Pub. Date: Jun. 8, 2006

(54) Composite panel for orthopedic technology; method for the manufacture and use thereof

(75) Inventors: Gerhard Graab, Mannheim (DE); Juergen Schmitt, Lorsch (DE); Manfred Noe, Laudenbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/086,925

(22) Filed: Mar. 22, 2005

(30) Foreign Application Priority Data
Mar. 23, 2004 (DE) 10 2004 014 609.8

(51) Int. Cl. B32B 5/20

(52) U.S. Cl. 428/316.6; 156/79

(57) ABSTRACT

A composite panel having at least two directly contiguous layers or sections of filler-containing foamed plastics, which are each composed of thermoplastic cross-linked and closed-cell foamed material, having at least different hardness and/or color and/or density, and which are bonded to one another without the use of an adhesive. The manufacturing takes place by the foaming and cross-linking of plastic layers in a press. The composite panel is suitable for use in orthopedic technology.

Priority is claimed to German Patent Application No. DE 10 2004 014 609.8-16, filed on Mar. 23, 2004, the entire disclosure of which is incorporated by reference herein.

The present invention is directed to a composite panel of foamed plastics having a specifically adjusted hardness, as well as to the manufacture and use thereof. The composite panel is suitable for use, in particular, as an insert in orthopedic technology.

### BACKGROUND

Today, foamed sole panels for use in orthopedic technology, preferably of ethylene-vinyl acetate copolymers in various thicknesses, different densities, hardness or color, are laminated to one another with the aid of adhesive agents or adhesive films, and are used further in this form, for example, for manufacturing orthopedic inserts.

The risk associated with such a manufacturing method is of the adhesive bond coming apart again during the subsequent required processing and deformation steps, under the influence of the required temperature and due to the mechanical stress during deformation. Moreover, this method is uneconomical, since substantial outlay is required to laminate the starting materials to form a composite product.

Composite panels for use in orthopedic technology are discussed in the German Application DE-A 36 39 505, U.S. Pat. No. 6,560,902, WO-A 96/12,420 and German Utility Model DE-U 200 12 844, the entire disclosures of each of which are incorporated by reference herein.

The German Patent Application DE-A-31 14 105 describes a method for manufacturing a relief-type grooved outsole from a closed-cell, cross-linked ethylene-co-vinyl acetate foam, as well as an outsole for shoes manufactured according to the method.

The European Application EP-A-329490 discusses a method for manufacturing a cross-linked polyolefin foam, which is used to prepare cross-linked polyolefin foams in the form of a multilayer structure, which have smooth surfaces and are readily deformable. In the process, a first layer made of polyolefin thermoplastic containing a foaming agent and a chemical cross-linking agent is combined with a second layer of polyolefin thermoplastic, which, for its part, merely contains a foaming agent. In a subsequent electron beam irradiation, the second layer is cross-linked and, in a subsequent thermal treatment, both the chemical cross-linking agent in the first layer, as well as the foaming agent in both layers decompose, thereby forming a foam structure having a soft surface. The use of the electron-beam cross-linking is limited to certain layer thicknesses, depending on the energy of the electron beam. Due to the interaction of the electron beam with the polymer, the degree of cross-linking is provided with a gradient in dependence upon the thickness of the material to be irradiated. This limits the use of electron-beam cross-linking, as does the fact that an electron-beam cross-linking system entails substantial investment costs.

### SUMMARY OF THE INVENTION

An object of the present invention is to provide a composite panel of foamed plastics of varying hardness, which are deformable under the action of heat, without separating into the individual layers during further processing.

An alternate or additional object of the present invention is to provide a composite panel for orthopedic technology composed of layers or sections of foamed plastics of different hardness, color, density, and deformation properties, which are permanently bonded to one another without the use of adhesive.

A further alternate or additional object of the present invention to provide a simple and economical method for manufacturing composite panels of foamed plastics of varying hardness.

The present invention is directed to a composite panel having at least two directly contiguous layers or sections of foamed plastics, which are each composed of cross-linked and closed-cell foamed and filler-containing material, having at least different hardness and/or color and/or density, and which are bonded to one another without the use of an adhesive.

Layered materials have different surface types, namely the surfaces defined by length and width and the surfaces defined by thickness and width or by thickness and length.

Within the framework of this description, directly contiguous layers are understood to be two layered materials which adjoin one another by a surface defined by width and length.

Also within the framework of this description, directly contiguous sections are understood to be two layered materials which adjoin one another by a surface defined by thickness and width and/or by a surface defined by thickness and length.

As a thermoplastic starting material for the composite panel according to the present invention, all thermoplastic plastics come into consideration, which are able to be processed into closed-cell foamed material, and which are able to be subjected to a cross-linking process, for example a process in which ethylenically unsaturated bonds are cross-linked by use of free radical formers.

Examples of these are polyethylene and copolymers of the ethylene having at least one comonomer, which belongs to the group of
vinyl esters of saturated carboxylic acids having up to four C atoms in the acid group, in particular vinyl acetate;
unsaturated mono- or dicarboxylic acids;
esters of unsaturated mono- or dicarboxylic acids having up to eight C atoms in the alcohol moiety;
α-olefins having four to ten C atoms.

In this context, the amount of ethylene units in the copolymer should be 40 to 95% by weight and the amount of comonomer units 5 to 60% by weight. The melt index of the copolymer should be between 0.1 and 50.

Preferably vinyl ester copolymers, more preferably vinyl ester-ethylene copolymers, and most preferably vinyl acetate-ethylene copolymers (also referred to in the following as “EVA”) are used.

These polymers may be combined in a method known per se, in a mixer with thermally decomposable expanding agents and cross-linking agents and, following manufacturing of the unfinished panels, be processed in a press into foamed and cross-linked molded articles. This is described with reference to molded articles of EVA, for example, in the German Application DE-A-31 14 105.

Examples of expanding agents are azo compounds, hydrazine derivatives, semicarbazides, tetrazoles and benzoxazines. Azodicarbonamide is preferred.

Examples of cross-linking agents are free radical-forming compounds, such as hydroperoxides, alkyl peroxides, peresters, diacyl peroxides and peroxyketals. Preferred are dicumyl peroxide or bis-(tert.-butylperoxyisopropyl) benzene, also in combination with cross-linking promotors, such as multi-functional acrylates, tri-functional cyanurates or isocyanurates.

In addition to expanding agents and cross-linking agents, the individual layers or sections of the composite according to the present invention have fillers. These may be the same or different fillers. Examples of fillers are natural or synthetic precipated calcium carbonates (chalk), hard, soft or calcined kaolins, mica, synthetic silicic acids, aluminum hydroxide, carbon black and graphite. It is especially preferred for synthetic silicic acid and/or chalk to be used as fillers.

Especially preferred composite panels contain silicic acid as filler in one layer or in one section, and chalk or a combination of chalk and silicic acid as filler in another layer or in another section.

The quantities of expanding agent, cross-linking agent and filler for the individual layers of the composite material are to be selected in each instance in such a way that a foamed plastic of the desired hardness and the desired density is formed.

Typical quantities of expanding agents range from 0.4 to 1.0% by weight, preferably from 0.8 to 2.5% by weight, based on the total amount of the material of one layer.

Typical quantities of cross-linking agents range from 0.2 to 1.0% by weight, preferably from 0.4 to 0.7% by weight, based on the total amount of the material of one layer.

Typical quantities of fillers range from 2 to 30% by weight, preferably from 3 to 20% by weight, based on the total amount of the material of one layer.

In accordance with the present invention, materials of the same basic composition are mutually subjected to a foaming and curing process, both the added cross-linking agent, as well as the expanding agent decomposing under the influence of the temperature and initiating the cross-linking process as well as the expanding process. In this context, the quantities of cross-linking agents, expanding agents, fillers and, as the case may be, of other additives in the individual layers are to be selected in such a way that cross-linked layers having different hardness and/or color and/or density result.

Preferred composite panels have two or more sections, which are bonded to one another via one dimension of the composite panel (thus, by the surfaces defined by length and thickness and/or by width and thickness), these sections differing by hardness and/or color and/or density.

When considered over their lengthwise or transversal extension, these composite panels, which are made up of sections, preferably have a symmetrical configuration and, thickness-wise, may be composed of only one layer.

In another preferred embodiment, when considered over their lengthwise or transversal extension, these composite panels, which are made up of sections, have an asymmetrical construction. Composite panels of this kind may be produced by cutting the original structure from symmetrically formed composite panels, the symmetrical configuration of the different hardnesses, colors and/or densities being disturbed, so that bodies composed of at least two sections are formed.

Other preferred composite panels have at least two directly contiguous layers of foamed plastics.

Preferred composite panels of this type have two or more layers, which are bonded to one another in each case via one dimension of the composite panel (thus, by the surfaces defined by length and width), these layers differing by hardness and/or color and/or density.

When considered over their lengthwise and transversal extension, as well as over their thickness, these composite panels, which are made up of layers, preferably have a symmetrical construction and are composed of at least two layers.

In another preferred embodiment, when considered over their lengthwise and transversal extension, these composite panels, which are made up of layers, have a symmetrical construction, and, when considered over their thickness, they have an asymmetrical construction. Composite panels of this kind may be produced by splitting off at least one layer of the original structure composed of symmetrically formed composite panels, the symmetrical configuration of the different hardnesses, colors and/or densities being disturbed, so that bodies composed of at least two layers are formed.

Especially preferred are three-layer composite panels which are constructed in such a way that a symmetrical structure of different materials is formed over the cross section (the thickness).

This symmetrical configuration prevents the occurrence of a so-called bimetal effect.

The selected composition of the materials ensures that both the cross-linking process, as well as the expanding agent decomposition, i.e., the evolution of gas are coordinated in such a way that a permanent bond of the different materials results in the end product. The advantage of this procedure is a permanent bond among the layers, which have different hardness, color, density and, thus, also different deformation behavior in the further processing.

The composite panels fabricated in this manner may still be split following the manufacturing process in order to selectively expose the harder or softer layers or parts thereof.

In some or all of the layers, the composite panels according to the present invention may, in some instances, still contain still other customary auxiliary agents. These are added as a function of the desired property profile and the method of processing the composite panel. Examples of such additives are dyestuffs, pigments and processing agents, such as metal oxides, for example, calcium oxide or magnesium oxide, zinc salts of fatty acids, fatty acid esters, fatty alcohols, fatty acids, fatty amides, fatty diamides, wax acids, polar polyethylene waxes, non-polar polyethylene waxes, paraffins, diethylene glycol, polyethylene glycol.

The present invention is also directed to a method for manufacturing the composite panel described above, including the measures of:
i) mixing thermoplastic and post-crosslinkable plastic with at least one expanding agent, at least one cross-linking agent, one or more fillers and, where necessary, other customary additives for preparing a first mixture;
ii) mixing thermoplastic and post-crosslinkable plastic with at least one expanding agent, at least one cross-linking agent, one or more fillers and, where necessary, other customary additives for preparing a second mixture which differs from the first mixture;
iii) producing a first layer or a first section from the first mixture in a generally known manner;
iv) producing a second layer or a second section from the second mixture in a generally known manner;
v) introducing the first layer, the second layer, and, in some instances, other layers or sections into a heatable press; and
vi) heating the heatable press to a temperature and setting a bonding pressure in such a way that the expanding agents of the first and second layer or section decompose, and closed-cell foams form in the first and the second layer or section, and the cross-linking agents of the first and second layer or sections effect a cross-linking of the thermoplastic plastic of these layers or sections, as well as a bonding of both layers or sections.

In accordance with the present invention, the materials for the individual layers are mixed beforehand in a generally known manner in mixing units, for example in an internal mixer or in a mixer extruder, and are each supplied as blank panels to the curing process. The blank panels may be fabricated in a customary manner, for example in a calendering process.

The curing process takes place in presses for fabricating closed-cell panels. For the EVA system described in the following, the temperature is typically between 150 and 180° C., preferably about 170° C. The bonding pressure is typically 150 to 250 atmospheres, preferably about 200 atmospheres.

The composite panels in accordance with the present invention are fabricated by simply compressing the individual layers under heat, thus without the use of radiation-induced cross-linking.

The raw materials for the individual layers are defined in accordance with length, width, and thickness, and in accordance with the intended application. Depending on the required thickness of the end product and desired composites, these raw materials are combined in such a way that an end product of different materials is formed.

The individual layers may be combined in the press in any desired manner. Besides superimposing individual layers to form composite panels having directly contiguous layers, individual layers may also be placed in the press directly adjoining one another side-by-side, in order to form sections of foamed plastics. Both types of layer sequences may also be combined with one another.

In one preferred embodiment of the method according to the present invention, a first layer from the first mixture, a second layer from the second mixture, and a third layer from the first mixture are introduced in succession into the heatable press, so that the individual layers come to rest one over another.

In another preferred embodiment of the method according to the present invention, a first layer from the first mixture, a second layer from the second mixture, and a third layer from the first mixture are introduced in succession into the heatable press, so that the individual layers come to rest side-by-side, directly adjoining one another, thereby enabling a composite panel having a plurality of sections to be formed.

The composite panels according to the present invention may be used as raw material in orthopedic technology and be advantageously processed into insoles or outsoles for shoes. The present invention is also directed to a use for these purposes.

### DETAILED DESCRIPTION

The following example illustrates the present invention without limiting it.

### EXAMPLES

The procedure for manufacturing a composite product of two EVA materials having different hardness and color is described in the following.

In a first step, two different EVA mixtures were mixed in the internal mixer at a mixing temperature of approximately 110° C. and a residence time of approximately 10 minutes.

Component A had the following composition:

| | |
|---|---|
| ethylene-vinyl acetate copolymer having a | 73% |
| vinyl acetate content of 15%: | |
| silicic acid filler: | 12% |
| pigments, processing agents: | 13% |
| expanding agents, for example azodicarbonamide: | 2.5% |
| cross-linking agents, for example dicumyl peroxide: | 0.5% |

In the cross-linked and foamed state, this mixture had a density of approximately 20 kg/m³ and a hardness of approximately 40 Shore A.

A second component B was composed of:

| | |
|---|---|
| ethylene-vinyl acetate copolymer having a | 72% |
| vinyl acetate content of 14%: | |
| chalk filler: | 14% |
| pigments, processing agents: | 6.4% |
| expanding agents, for example azodicarbonamide: | 7% |
| cross-linking agents, for example dicumyl peroxide: | 0.6% |

and was mixed in the same manner as component A. In the final state, this mixture B had a density of 8 kg/m³ and a hardness of approximately 18 Shore A.

From both mixtures, 4 mm thick panels were fabricated in a calendering process, in a dimension that was oriented to the size of the curing mold and combined with one another at the press in such a way that mixture A came to rest in each case in the middle between a layer of mixture B.

This composite was placed in the compression mold and heated at a temperature of between 150 and 180° C., preferably at 170° C., and, depending on the thickness of the product to be manufactured, for example a product having a 24 mm final thickness, heated for a time period of 28 minutes, and expanded after expiration of the heating time by opening the press.

Thus, a composite product was formed from materials having a different hardness, different density, different color, and a different deformation property, whose layers were no longer able to be separated.

Analogously to this method, the panels of mixtures A and B were able to be placed in the press against one another in such a way that two abutting edges touched one another. Thus, as the result of a pressing and heating process, a permanent bond was able to be produced between the two sections.

What is claimed is:

1. A composite panel comprising:
a first section of a first foamed plastic including a first cross-linked and closed-cell foamed material containing a first filler; and
a second section of a second foamed plastic including a second cross-linked and closed-cell foamed material containing a second filler, wherein the first and second sections are directly contiguous with one another and bonded to each other without an adhesive, and wherein the first and second sections have at least one of a different hardness, a different density and a different color.

2. The composite panel as recited in claim 1, wherein the first section is a first layer and the second section is a second layer.

3. The composite panel as recited in claim 1, wherein the first and second cross-linked and closed-cell foamed materials include an ethylene-vinyl acetate copolymer.

4. The composite panel as recited in claim 3, wherein the ethylene-vinyl acetate copolymer is foamed using of azodicarbonamide.

5. The composite panel as recited in claim 3, wherein the ethylene-vinyl acetate copolymer is cross-linked using at least one of an organic peroxy acid and a peroxide.

6. The composite material as recited in claim 5, wherein the peroxide includes dicumyl peroxide.

7. The composite panel as recited in claim 1, wherein the first filler contains silicic acid, the second filler contains at least one of chalk and a combination of chalk and silicic acid.

8. The composite panel as recited in claim 2, wherein the first and second layers each include a surface defined by a length and a width, the surfaces being bonded to one another.

9. The composite panel as recited in claim 8, further comprising a third layer having a third surface bonded to a further surface of one of the first and second layers.

10. The composite panel as recited in claim 8, wherein the panel has symmetrical construction with respect to its length, width, and thickness.

11. The composite panel as recited in claim 10, further comprising a third layer so as to form a three-layer construction and a symmetrical configuration of different materials over a cross section of the panel.

12. The composite panel as recited in claim 8, wherein the panel has symmetrical construction with respect to its length and width, and an asymmetrical construction with respect to its thickness.

13. The composite panel as recited in claim 1, further comprising a third section and a fourth section, each having a surface defined by a length and one of a width and a thickness, the surfaces being bonded to one another, the panel having a symmetrical construction with respect to its length and width, and wherein the third and fourth sections have at least one of a different hardness, a different density and a different color.

14. The composite panel as recited in claim 1, wherein the first and second layers each include a surface defined by a length and one of a width and a thickness, the surfaces being bonded to one another, and wherein the panel has an asymmetrical construction with respect to its length and width.

15. A method for manufacturing a composite panel having first and second sections, the method comprising:
mixing a first thermoplastic and crosslinkable plastic with at least one first expanding agent, at least one first cross-linking agent, at least one first filler so as to provide a first mixture;
mixing a second thermoplastic and crosslinkable plastic with at least one second expanding agent, at least one second cross-linking agent, at least one second filler so as to provide a second mixture, the second mixture differing from the first mixture;
creating a section of the composite panel from the first mixture;
creating a second section of the composite panel from the second mixture;
introducing the first section and the second section into a heatable press; and
heating the heatable press to a predetermined temperature and setting a predetermined bonding pressure such that the first and second expanding agents decompose so as to form closed-cell foams the first and second sections and cross-linking agents of the first and second sections effect a cross-linking of each of the first and second thermoplastic plastics as well as a bonding of the first and second sections.

16. The method as recited in claim 15, wherein the first and second sections form first and second layers.

17. The method as recited in claim 16, further comprising further providing further sections and introducing the further sections into the heatable press with the first and second sections.

18. The method as recited in claim 15, wherein the first and second thermoplastic and crosslinkable plastics includes ethylene-vinyl acetate copolymer.

19. The method as recited in claim 15, wherein at least one of the first and second expanding agents includes azodicarbonamide.

20. The method as recited in claim 15, wherein the at least one of the first and second cross-linking agents includes an organic peroxide.

21. The method as recited in claim 20, wherein the organic peroxide includes a dicumyl peroxide.

22. The method as recited in claim 15, wherein the first fillers includes silicic acid and wherein the second filler includes one of chalk and a combination of chalk and silicic acid.

23. The method as recited in claim 15, wherein the predetermined temperature is 150 to 180° C. and the predetermined bonding pressure is 150 to 250 atmospheres.

24. The method as recited in claim 15, further comprising providing a third section from the first mixture and wherein the introducing includes introduced the first, second and third sections in succession into the heatable press.

25. The method as recited in claim 24, wherein the introducing is performed so that the first, second and third sections come to rest side-by-side, directly adjoining one another, thereby enabling a composite panel having a plurality of sections to be formed.

26. The method as recited in claim 1, wherein the composite panel is part of one of a shoe insole and a shoe outsole.
